(19) United States
(12) Patent Application Publication
(10) Pub. No.: US 2025/0173641 A1
(43) Pub. Date: May 29, 2025

(54) DYNAMIC TALENT MATCHING

(71) Applicant: OBRIZUM GROUP LTD., Cambridge (GB)

(72) Inventors: Chibeza Agley, Cambridge (GB); Matthew Jonathan Chadwick, Stroud (GB); Vishnu Hariharan Anand, Cambridge (GB); Wedad Zein, Cambridge (GB); Christopher Pedder, Leysin (CH)

(21) Appl. No.: 18/521,575

(22) Filed: Nov. 28, 2023

(51) Int. Cl. G06Q 10/0631; G06F 40/20

(52) U.S. Cl. CPC G06Q 10/063112; G06F 40/20

(57) ABSTRACT

A system identifies a first path taken by a learner in a concept space relative to a plurality of concept nodes that are contextualized within the concept space according to an embedding dimension of an embedding mechanism, transforms the first path in the concept space into a second path in a job space comprising a plurality of job nodes that are contextualized within the job space according to the embedding dimension of the (same) embedding mechanism, determines a distance between a first point on the second path and a first job node of the plurality of job nodes, computes an affinity of the learner for a job of the first job node based on the distance, and reports the affinity. Mechanisms for a “reverse” process that transforms a desired affinity for a job into a learning plan with respect to the content mapped in the concept space are also discussed.

### TECHNICAL FIELD

This application relates generally to methods for evaluating of a person's competencies with respect to jobs/roles within an organization, and/or to the identification of content that a person can learn in order to increase their affinity for a particular job/role within an organization.

### BACKGROUND

Making links between a person's existing competencies (e.g., their performance skill set for a particular job or position) and current and future job roles is a significant problem in the modern economy. In some cases, such evaluations are performed in a heavily manual fashion by human resource (HR) teams or other personnel of an organization at significant cost in person-hours. Further, under such circumstances, there is a real risk of subjective bias and other human judgement factors creeping into the process to the disadvantage of particular individuals and/or groups.

In other cases, such evaluations may be automated in whole or in part. In such cases, the automated process often depends on incomplete and/or static “skills ontologies” created by organizations, which can be invariably backward-looking and therefore unsuitable for a world in which both skills and roles develop quickly. Further, in cases where a job suitability screening processes are done using automated methods using previous data to make matching/analogous decisions (e.g., as may be the case when using a supervised machine learning process) there is a real risk of perpetuating existing biases represented within the historical data.

Further, in many instances individuals in organizations may not be aware of skills required for advancement or the educational options to achieve such skills that may be offered within the organization. This can result in many talented individuals not advancing within an organization, despite having the talent and drive to do so.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example computing system according to various aspects of the present disclosure.

FIG. 2 illustrates a diagram showing aspects of a comparative analysis between a concept space and a job space, according to embodiments discussed herein.

FIG. 3 illustrates a user interface for presenting affinities of various candidates for various roles, according to embodiments herein.

FIG. 4 illustrates a user interface for presenting affinities of various per-concept-space candidates for various roles, according to embodiments herein.

FIG. 5 illustrates aspects for generating a learning recommendation using a concept space and a job space, according to embodiments discussed herein.

FIG. 6 is a schematic diagram of a computing system which may be used to implement various embodiments in the examples described herein.

FIG. 7 illustrates a method of a computing system, according to embodiments discussed herein.

FIG. 8 illustrates a method of a computing system, according to embodiments discussed herein.

FIG. 9 illustrates a method of a computing system, according to embodiments discussed herein.

### DETAILED DESCRIPTION

Systems and methods for providing granular, relevant information to actor(s)(e.g., individuals) in an organization responsible for performing competency evaluation procedures (e.g., managers, HR professionals) in a way that minimizes and/or eliminates bias risk are beneficial to the organization for various reasons. For example, having this information allows the organization to more accurately direct/assign its existing personnel within the organization to jobs/roles where they can create the most value. Further, by configuring a computer system to gather or provide this information in a systematic and streamlined manner, overall hiring costs expended by the organization may be reduced.

It is also the case that more and more organizations are delegating responsibility for learning and development aspects with respect to existing personnel to HR departments. Accordingly, tight couplings are developing between traditional HR aspects and personnel development aspects within such organizations. It has been recognized that in such cases, this coupling (e.g., corresponding to feedback as between HR aspects and personnel development aspects) can be leveraged such that both HR aspects and personnel development aspects benefit in a symbiotic way. This symbiosis extends to the use of data derived from learning and development functions for, for example, multi-dimensional measurement of a suitability of internal candidates for open roles (e.g., based on their educational history and/or prior performance within the organization).

Further, it has also been recognized that by inverting such a “map” from learning and development histories for such candidates to job recommendations, it is possible to, for example, based on a candidate's ambitions for a future role, identify and construct a group of learning materials that will prepare them well for that role and that takes into account their current competencies/their current job/role. By providing automated skill assessment and identification, computer systems that may be integrated into HR processes can more meaningfully, as well as more efficiency and effectively, provide dynamic matching, skill path trajectories, and career guidance to both individuals (e.g., employees, contractors, etc.) working for an organization or entity, as well as assist in providing more non-biased feedback and alignment for HR professionals when screening or otherwise considering individuals for a particular job or opening.

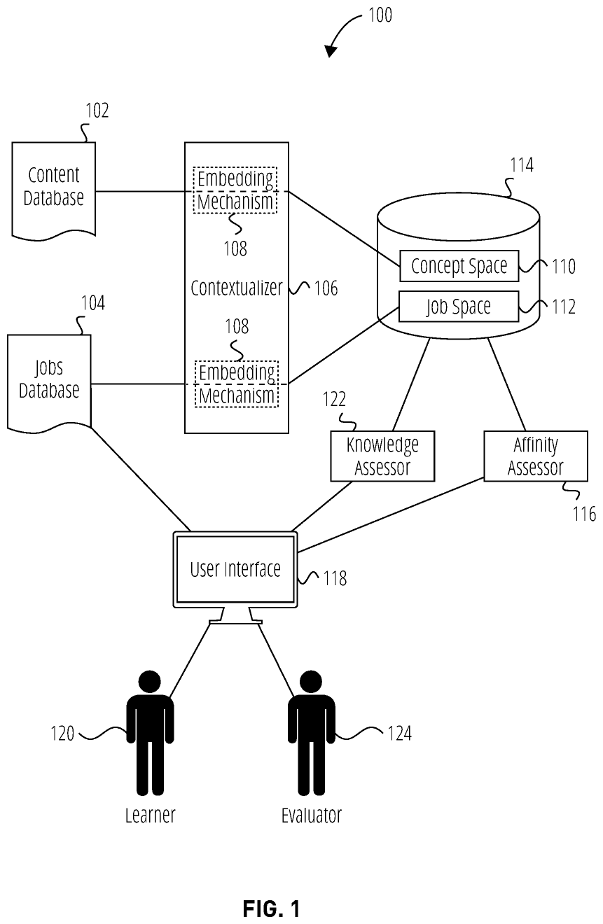

FIG. 1 illustrates a block diagram of an example computing system 100 according to various aspects of the present disclosure. As illustrated, the computing system 100 accesses a content database 102 and a jobs database 104 with/through a contextualizer 106. The contextualizer 106 uses an embedding mechanism 108 with the content database 102 to generate a concept space 110. Further, the contextualizer 106 may use the (same) embedding mechanism 108 with the jobs database 104 to generate a job space 112. Each of the concept space 110 and the job space 112 are stored/made available within in a space database 114 of the computing system 100.

In some examples, the content database 102 includes learning or informational content items and/or materials. Examples of learning content include videos, slides, papers, presentations, images, questions, answers, product descriptions, sound clips, and 3D models (e.g., deoxyribose nucleic acid (DNA), computer-aided design (CAD) models), testing lab procedures, data presented in an augmented reality (AR), virtual reality (VR), and/or mixed reality (MR) environment, etc. In non-limiting examples, additional content that may be presented in an VR/AR/MR environment may include three-dimensional (3D) models overlaid in an AR environment, links of information related to product datasheets (e.g., marketing pieces, product services offered, etc.), a script that underlies a video, voice or text that may be overlaid in an AR environment. As should be appreciated, the learning or informational content can include various types of media, such as a video file, audio file, and/or a text file. The content may in some cases be a live audio and/or video stream captured from audio/video sensors or other suitable sensors. The type and format of the content items may be varied as desired and as such the discussion of any particular type of content herein is meant as illustrative only. The content items in the content database 102 may include a wide range of information encompassing various subjects and/or topics.

In some examples, the jobs database 104 includes job information about jobs of an organization. For example, the jobs database 104 may include textual listings for the plurality of jobs. These listings may discuss/relate necessary and/or desirable skills for the corresponding jobs within the organization. In some instances, the job information in the jobs database 104 may be taken from another database (e.g., a hiring/positions database of the organization). In some instances, it is contemplated that jobs listings in the jobs database may be supplemented/updated by internal information generated within/used by the organization as related to those jobs, such as internal career ladder information defining a skills path for those jobs and/or a competency matrices for those jobs. In some instances, it may be that an evaluator 124 of the computing system 100 can operate a user interface 118 of the computing system 100 to add, delete, and/or modify job information in the jobs database 104.

In some examples, the jobs database 104 includes job information about jobs that are external to the organization hosting the computing system 100. For example, the jobs database 104 may include textual listings for jobs as taken from a third party resource (a resource that is external to the organization). Example sources for such information may be, for example, a jobs database (other than the jobs database 104) hosted by another organization, generalized job listings (e.g., as taken from the internet), etc.

The contextualizer 106 may be configured to apply the embedding mechanism 108 with the information in a database (e.g., the content database 102 and/or the jobs database 104) to generate spaces (e.g., the concept space 110 and/or the job space 112) comprising a plurality of nodes for that space. Such a use of the embedding mechanism 108 of the contextualizer 106 on information (e.g., database information) may be referred to herein as “contextualization.” The contextualizer 106 may thus be understood to “contextualize” the information from a database into a related space by creating geometric representations corresponding to the information in the database in a high-dimensional space (e.g., in more than 3 dimensions).

Such a procedure may be referred to herein as “embedding.” The embedding procedure may operate according to an embedding dimension that controls the number, nature, and/or placement of the nodes in a space. For example, the embedding mechanism may arrange the content of the database to be represented by a number of nodes that is controlled by the embedding dimension. Then, the procedure may place each of the nodes into its related space in a manner that is corresponds to the embedding dimension.

In some cases, the embedding mechanism 108 therefore focuses on particular themes or topics in natural language associated with the information in a database. In such cases, the embedding mechanism 108 may be a large language model (LLM) that parses the textual information of (or corresponding to) the information of the database into the plurality of nodes according to the embedding dimension, and then places the nodes within the related space, in the manner described.

As illustrated, the contextualizer 106 may be configured to apply the embedding mechanism 108 with the (e.g., textual) information in/corresponding to the content of the content database 102 to generate a high-dimension concept space 110 comprising a plurality of “concept nodes.” These concept nodes each represent the association of one or more pieces of the content from the content database 102 to the concepts represented in the concept space 110 as these concepts are established according to the nature of the embedding dimension used by the embedding mechanism 108.

The embedding mechanism 108 further places these concept nodes into the high-dimensional concept space 110. A placement of a concept node in the concept space 110 may represent a relationship of the concept node to concepts of the embedding dimension used. Contextualization/embedding for the concept space 110 thus may be understood to occur according to a number of concepts drawn according to the use of the selected embedding mechanism 108 and that represent themes by which concept nodes may be arranged or understood. These concepts are described by an embedding vector, which is M-dimensional, with M corresponding to the dimension of the concept space as defined/controlled by the embedding mechanism 108. The contextualization of the concept space 110 may be understood to form K, an N*M dimensional matrix, in which N is the number of concept nodes in the space (and where M is the dimension of the embedding vector).

According to this embedding-dimension-controlled placement, it may be understood that a pair of concept nodes that each correspond well to relatively more related concept(s) contextualized in the concept space may have less distance between them than a pair of concept nodes that do not each correspond well to similar concept(s) (and this property may hold true across all concept nodes of the concept space 110). Note that because a strength of relationship between concepts may vary, distances between concept nodes can accordingly vary. Note that, as used herein, the term “distance” as between nodes should be understood broadly. In some cases a measure of “distance” may be a Euclidean distance. However, other metrics for determining a “distance” are contemplated. For example, a “distance” could be calculated based on a cosine similarity between two nodes, or based on some other type of metric that evaluates a relative relationship between two nodes.

The concept nodes of the concept space 110 and the corresponding interconnections (e.g., representing the distances there between) may be understood as a high-dimensional graph. This graph of the concept nodes and their interconnections may correspondingly be understood as a representation of the concept space 110.

The purpose of this contextualization of information from the content database 102 by the embedding mechanism 108 (and according to the concepts represented by the embedding mechanism 108) may be to enable organized consideration of the content of the content database 102 in a concept-wise basis.

In some cases, it is possible to create group(s) of keywords defining given concept(s), and that an evaluator 124 (e.g., a manager, a HR professional, etc.) provides such group(s) of keywords to the contextualizer 106 to better define appropriate topics for contextualization. The contextualization process can also involve the use of neural embeddings from large language models like a bidirectional encoder representations from transformers (BERT) model or a generative pre-trained transformer (GPT) model.

It has been recognized that once a contextualization has been defined for/used to generate the concept space 110, it is also possible to apply it to, for example, free text job or role descriptions and/or skills combinations which are required and/or desirable to perform a particular task or function, as may be found in the jobs database 104.

Accordingly, as also illustrated, the contextualizer 106 may (e.g., further) be configured to apply the embedding mechanism 108 with the (e.g., textual) information in/corresponding to the jobs database 104 to generate a high-dimension job space 112 comprising a plurality of “job nodes.” These job nodes represent an association of one or more jobs represented in the jobs database 104 to concepts established according to the nature of the embedding dimension used by the embedding mechanism 108.

To bolster/improve the use of job role descriptions for connecting to skills frameworks, query expansion may be used with the information of the jobs database 104 when or as part of applying the embedding mechanism 108 with the information of the jobs database 104. This may help alleviate the effects of redundant and/or very specific language that may be found in the information of the jobs database 104. This query expansion may occur through, for example, the an explicit ontology derived from existing skills frameworks and/or by using syntactic replacement of words and/or sentences using neural models and/or LLMs to enrich the information. In some cases, a LLM of the embedding mechanism 108 may also be configured to perform such a query expansion.

The embedding mechanism 108 proceeds to places the job nodes into the high-dimensional job space 112. A placement of a job node in the high-dimensional job space 112 may represent a correspondence of job(s) represented by that job node to the concepts of the embedding dimension used.

Further, the contextualization of the plurality of job nodes in the job space may also be understood to correspond to job characteristics of a plurality of jobs represented by the plurality of job nodes, as those characteristics are described in the jobs information from the jobs database 104.

In cases as described here, where the same embedding mechanism 108 is used to generate the job space 112 as was used to generate the concept space 110, if the number of job roles is R, the contextualization/embedding of the information in the jobs database 104 results in J, an R*M matrix of job role embeddings (where, again, M is the dimension of the applicable embedding vector used by the embedding mechanism 108).

According to this embedding-dimension-controlled placement, it may be understood that a pair of job nodes for relatively more related jobs may have less distance between then than a pair of job nodes for relatively less-related or unrelated jobs (and this property may hold true across all concept nodes of the job space 112). Note that the term “distance” as used here should be understood broadly (e.g., the “distance” is not limited to a Euclidean distance, but could instead be a cosine similarity or some other metric for evaluating a relative relationship between nodes). Note also that because a strength of relationship between jobs may vary, distances between job nodes can accordingly vary. The job nodes of the job space 112 and the interconnections (e.g., representing the distances there between) may be understood as a high-dimensional graph. This graph of the job nodes and their interconnections may be understood as a representation of the job space 112.

The purpose of this contextualization of information from the jobs database 104 by the embedding mechanism 108 (and according to the concepts represented by the embedding mechanism 108) may be to enable organized analysis of job information in a concept-wise manner that corresponds to the concept-wise organization of concept nodes of the concept space 110. This is possible because (e.g., when) the contextualizer 106 uses the same embedding mechanism 108 to perform each of a first embedding of the jobs database 104 and a second embedding of the jobs database 104. In other words, because each of the concept space 110 and the job space 112 are generated by the same embedding mechanism 108 reflecting a (single) concept division schema, a conceptual relative correspondence between the concept space 110 and the job space 112 exists.

The computing system 100 may further include a user interface 118 through which a learner 120 and/or an evaluator 124 may interact with the computing system 100. The user interface 118 may include one or more of a keyboard, monitor, mouse, microphone, speaker, touchscreen, and/or any other known user interface device as may be common and/or known in the art. It is contemplated that in at least some cases, the user interface 118 may interact with other hardware of the computing system 100 over a network, (e.g., according to a client-server networked relationship).

As discussed herein, a learner 120 of the computing system 100 may be, for example, an employee or independent contractor of an organization that operates the computing system 100 in order to become more proficient with one or more concepts (e.g., those that may be correlated with particular skills such as those for jobs or other positions) as represented in the concept space 110. Further, an evaluator 124 of the computing system 100 may be a manager, HR professional, etc., that uses the computing system 100 to evaluate one or more learners 120 users of the computing system 100, as is described herein.

The computing system 100 may further include a knowledge assessor 122 that assesses the knowledge of a learner 120 with respect to one or more concepts of the concept space 110. For example, the knowledge assessor 122 may be coupled to the user interface 118 and use the user interface 118 to present content corresponding to one or more of the concept nodes of the concept space 110 to the learner 120 and to receive data representing to the knowledge of the learner 120 of the concepts for the corresponding concept node(s) as the user engages the content. The knowledge assessor 122 then analyzes this user knowledge data to evaluate a level of proficiency/affinity of the learner 120 with respect to the applicable concept nodes of the concept space 110. Accordingly, in some examples, the knowledge assessor 122 may incorporate a testing environment that displays questions for the learner 120 to answer. In such cases, the knowledge assessor 122 may further receive and use various user assessment variables within this context, such as the veracity of the learner 120, the response time of the learner 120, and/or a confidence indicated by the learner 120 when answering a question, etc.

The computing system 100 further includes an affinity assessor 116 that may perform one or more comparative analyses between the concept space 110 and the job space 112. In some cases, the goal/result of such an analysis may be determine a fitness of the learner 120 for a job represented by a job node in the job space 112 based on a location of the learner 120 in the concept space 110, as is further described herein. In some cases, the goal/result of such an analysis may be to determine one or more content items of the content database 102 which a learner 120 should begin learning in order to become more fit for a job represented in the job space 112, as is further described herein. The affinity assessor 116 accesses the space database 114 to perform such analyses. The affinity assessor 116 may accomplish these result(s) through the evaluation of relevant locations in the concept space 110 to their corresponding locations in the job space 112 (or vice versa), as is described herein.

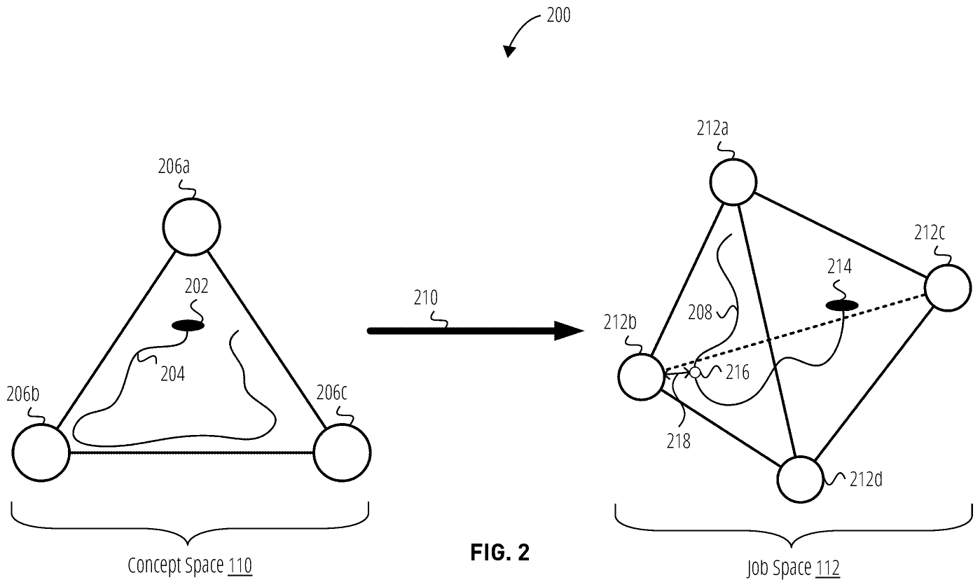

FIG. 2 illustrates a diagram 200 showing aspects of a comparative analysis between a concept space 110 and a job space 112, according to embodiments discussed herein.

As a learner 120 interacts with content corresponding to the concept nodes 206a, 206b, and 206c of the concept space 110 (e.g., through interaction with the knowledge assessor 122 of the computing system 100), they trace out, beginning at a starting point 202, a concept space path 204 among the concept nodes 206a, 206b, and 206c in the concept space 110. Note that while the learner 120 travels along the concept space path 204, their location within the concept space 110 at any given point is given by an N-dimensional vector, the i-th entry of which defines their affinity for the i-th concept node in the concept space 110.

Then, because each of the concept space 110 and the job space 112 are contextualized according to the same embedding mechanism 108, a job space path 208 for the learner 120 can be determined based on the concept space path 204.

To map locations in the concept space 110 to locations in the job space 112, the computing system 100 (e.g., the affinity assessor 116) may construct/use an N*R dimensional “dyadic” matrix K·J^{T} (where T is the transpose operation). This matrix may be denoted herein as L. Then, given an M-dimensional location in the concept space eₖ, a corresponding M-dimensional location in job space eⱼ may be determined by an operation 210 using eₖ and L as follows in Equation (1):

$${e}_{j} = {L}^{T} {e}_{k} \qquad Eq . ( 1 )$$

FIG. 2 illustrates the case where points on the concept space path 204 have been mapped to corresponding points on the job space path 208 through the use of the operation 210. Note that in FIG. 2, the starting point 202 of the learner 120 on the concept space path 204 in concept space 110 corresponds to the starting point 214 of the learner 120 on the corresponding job space path 208 in the job space 112.

Then, corresponding to the job space path 208, an affinity of a the learner 120 to jobs/roles represented at the job nodes 212a, 212b, 212c, and 212d may be understood as a vector of numbers, where each number corresponds to a distance (e.g., a distance of closest approach) on the job space path 208 to the respective job nodes 212a, 212b, 212c, and 212d. In some such cases, it may be that these numbers are normalized (e.g., to run between 0 and 1, where 0 denotes total unsuitability, and 1 denotes a perfect match of the learner 120 to the job/role).

For example, the illustrated point 216 on the job space path 208 corresponds to a distance of closest approach 218 from the job space path 208 to the job node 212b. Accordingly, the value for the job node 212b in the vector of numbers for the job space path 208 of this learner 120 (the affinity of the learner for a job represented by the job node 212b) may be controlled by/calculated using this distance of closest approach 218.

As the human brain does not perfectly retain all gained knowledge over time, it is contemplated that in some instances it may be desirable, when evaluating affinities of the learner 120 with respect to the job nodes 212a, 212b, 212c, and/or 212d as described, to take into account an amount of time that has passed since a particular point has been generated by the learner 120 in the concept space 110. Accordingly, in some embodiments, it may be that time information corresponding to the various points of the concept space path 204 (and thus the corresponding points on the job space path 208) is tracked by and/or otherwise known to the computing system 100. This time information may relate, for example, a time (e.g., date, day, year, etc.) during which the learner 120 was deemed to be located at a given point on the concept space path 204 (and thus the corresponding point on the job space path 208).

Then, it may be that a penalty with respect to an amount of time may be applied to one or more points on the concept space path 204 (and thus the job space path 208) in order to account for the possibility that the learner 120 will forget knowledge over longer time frames. In such embodiments, it may be understood that, for example, a selection of a point on a job space path 208 corresponding to a closest approach may be limited to points of the job space path 208 that have been generated within a given time frame, and/or that points on the job space path 208 that are outside a given time frame may be treated as further from the job node in question than they otherwise appear for purposes of affinity evaluation. In some embodiments, the effects of such penalties may be exponential in time.

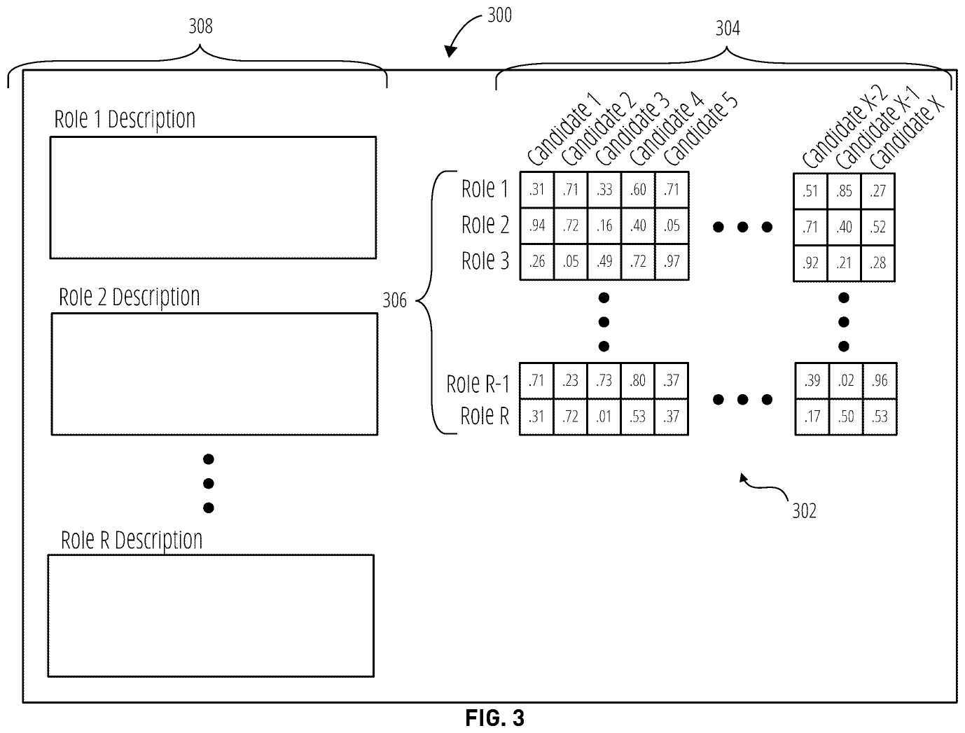

FIG. 3 illustrates a user interface 300 for presenting affinities 302 of various candidates 304 for various roles 306, according to embodiments herein. The user interface 300 may be displayed, for example, on the user interface 118 of the computing system 100. The candidates 304 may represent different learner users (e.g., as in the example learner 120 discussed in relation to FIG. 2), where “candidate” labelling is used here alternatively to fit the context that may be expected by the evaluator 124 of the computing system 100 that is a manager, an HR professional, etc. Accordingly, it should be understood that any individual “candidate” discussed herein may be a learner 120 as has is described herein.

Each column within the affinities 302 corresponds to a different one of the candidates 304. It may be that the computing system 100 computes a job space path within a job space for each of these candidates 304 (e.g., in the manner that was discussed in relation to FIG. 2). Then, the computing system 100 displays the corresponding vector of numbers for distances (e.g., the distance of closest approach) on the job space path of that respective candidate to each of the roles 306 (where the distance is evaluated with respect to a job node in the job space for that one of the roles 306). Note that the terms “roles” and “jobs” may be used interchangeably herein. As illustrated, in some cases these numerical distances may be normalized (e.g., to run between 0 and 1), in the manner discussed herein. Note that in the illustrated case, a relatively lower number represents a relatively smaller distance (and thus a relatively better fit) between the candidate and the role.

By providing these distances, managers/HR professionals are enabled to identify roles that might be applicable to the learning of one or more of the candidates 304. This distance can be further expanded into a set of distances on a per-node basis, allowing HR professionals to understand where the candidate is particularly strong or weak.

Note that in some cases alternative to those illustrated here, the affinities 302 may not be provided directly as a numerical value, as illustrated. Rather, the affinities 302 may be represented using each illustrated square according to a color key that uses colors to visually indicate/correspond to the underlying numerical values of the affinities 302 (e.g., a color key that travels from dark red→light red→light green→dark green as the corresponding distance value decreases/as the corresponding affinity of the candidate for the role increases). This may facilitate a more straightforward/natural interpretation of the affinities 302 for the learner as displayed by the user interface 300.

The user interface 300 may also display role descriptions 308 corresponding to the roles 306. This may aid the evaluator 124 in understanding better the natures of the roles 306 for which the candidates 304 are being evaluated by way of the affinities 302. The role descriptions 308 may match and/or be drawn from the job information as found in the jobs database 104 that was originally contextualized.

Further, it is contemplated that in at least some cases, the evaluator 124 may be able to modify the text within these role descriptions 308. This may cause the computing system 100 to update the corresponding content in the jobs database 104, though this is not strictly required. Further, this new/changed information may trigger the computing system 100 re-contextualize the job space 112 based on/taking account of the new/changed information, re-determine any job space paths for the users within this re-contextualized job space 112, and finally recalculate corresponding affinities 302 and update these to the user interface 300, consistent with the mechanisms for these procedures as described herein. In this way, the computing system 100 allows the evaluator 124 to dynamically assess various/arbitrary combinations of job role characteristics and the fit of various ones of the candidates 304 thereto.

Similarly, it is contemplated that an evaluator 124 could, at this stage, provide a freeform description of job/role the organization currently wishes to fill in one of the role descriptions 308 in order to dynamically assess which personnel are currently the most advanced in the corresponding skills (e.g., so that they can be considered for further training in order to fill existing or anticipated skills gaps within the organization).

It is contemplated that a computing system 100 could create/operate with multiple concept spaces (e.g., the concept space 110 and one or more additional concept spaces). Such an additional concept space(s) may relate to content database(s) that are other than/in addition to the content database 102.

It may be that such additional concept spaces are contextualized (e.g., by the contextualizer 106 of the computing system 100) by/according to the same embedding mechanism 108 that was used to generate the concept space 110 and the job space 112. Accordingly, such additional concept spaces have a conceptual relative correspondence to the job space 112.

In other cases, such additional concept spaces may be contextualized (e.g., by the contextualizer 106 of the computing system 100) according to a different embedding mechanism than the embedding mechanism 108 that was used to generate the concept space 110 and the job space 112. In such cases, it may be that the computing system 100 further contextualizes additional job spaces (other than the job space 112) that have conceptual relative correspondence to these additional concept spaces according to the applicable (different) embedding mechanisms using the job information from the jobs database 104. Note that in such cases, the shape of/relative placement of the job nodes in the new/additional job space may be different from the job space 112, while the number of job nodes (and the jobs/roles represented at each of the job nodes) may remain consistent across the different job spaces (e.g., R remains constant across these different job spaces).

To handle the possibility that a learner 120 has followed content in one or more of several possible concept spaces known to/used in the computing system 100, any applicable contextualization/embedding mechanism(s) used for each concept space may control the contextualization of the job roles in a conceptually relative job space to that concept space, as just described. Then, the computing system 100 may carry out analogous procedures as described herein for generating vectors of numbers corresponding to learners/candidates with respect to the each concept space-job space pairing individually.

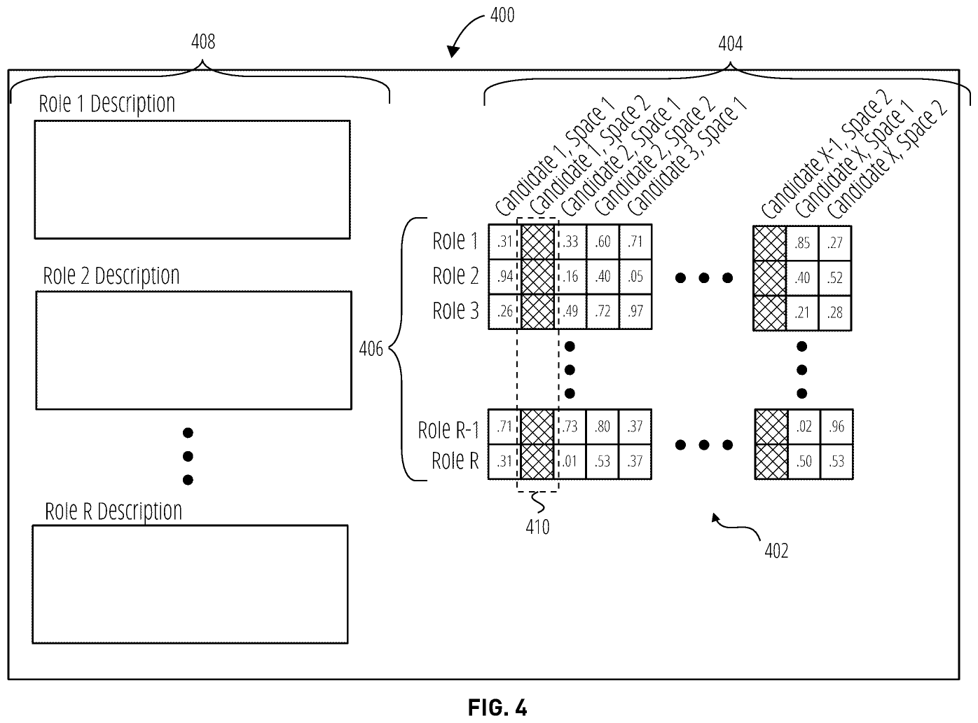

FIG. 4 illustrates a user interface 400 for presenting affinities 402 of various per-concept-space candidates 404 for various roles 406, according to embodiments herein. The user interface 400 should be understood to correspond to operations of the computing system 100 that may be further modified with respect to those previously described in in the discussion of FIG. 3. Accordingly, the affinities 402, the roles 406, and the role descriptions 408 may be analogous to entities of the same name that were described in FIG. 3.

However, in FIG. 4, each column of per-concept-space candidates 404 in the affinities 402 in this case represents a vector of numbers for a learner/candidate with respect to the roles 406 as determined within the context of one of multiple possible concept spaces. Accordingly, as illustrated in FIG. 4, some candidates in the per-concept-space candidates 404 are represented twice with respect to each of two concept spaces (“Space 1” and “Space 2”). Note that the use of two concept spaces is given here by way of example only—this aspect may be expanded up to any number of concept spaces in play.

Since the output of the vector of numbers for any concept space-job space paring may be normalized (e.g., to between 0 and 1), and because (at least) the per-node representation of the jobs/roles across the job space(s) in play remains consistent, is possible to directly compare an affinity of a given one of the per-concept-space candidates 404 for the roles 406 with respect to the concepts from each different concept space, as illustrated. Note that because the per-node representation of the jobs/roles across the job space(s) in play remains consistent, this remains the case even when contextualization(s)/embedding mechanism(s) used are different with respect to various ones of the applicable concept space-job space pairings.

As before, the evaluator 124 may be able to modify the text within the role descriptions 408. This may cause the computing system 100 to update the corresponding content in the jobs database 104, though this is not strictly required. Further, this new/changed information may trigger the computing system 100 re-contextualize the job space(s) based on/taking account of the new/changed information, re-determine any job space paths for the candidates within these re-contextualized job space(s), and finally recalculate corresponding affinities 402 and update these to the user interface 400, consistent with the mechanisms for these procedures as described herein.

Corresponding to such cases, if a candidate has not carried out work in a particular concept space where others have, a corresponding indication 410 may be made with respect to the vector of numbers for that candidate in the corresponding column (in FIG. 4, this is illustrated with a “grey out” of the boxes of the corresponding column in the user interface 400).

The use of multiple concept spaces may be applicable in a case where, for example, the organization allows learners to operate/learn with respect to content in multiple content databases corresponding to the multiple concept spaces.

Additionally or alternatively, it could be that an existing concept space, along with its attendant concept space path(s) for a learner (but separate from its corresponding content database) that has been generated elsewhere is imported into the computing system 100 for use. This may correspond to a case where, for example, where it is desirable to receive useable concept space paths for a learner 120 that has not been directly evaluated by a knowledge assessor 122 of the present instance of the computing system 100 (which may be the case in, for example, in a hiring evaluation context, where the learner 120 is a candidate that is being considered as a new addition to the organization). In such cases, the current computing system 100 may be configured to either first verify that the same embedding mechanism 108 was used at the other instance of the computing system 100 in order to ensure compatibility of the new concepts space with the existing job space 112 (as could be the case when the embedding mechanism 108 across various instances of the computing system 100 is provided by/controlled by a vendor of the various instances), and/or to further receive/use a new embedding mechanism corresponding to the new concept space for use to generate a new job space that represents the current organization's roles in a manner that is compatible with the new concept space.

For example, in the event that instances of the computing system 100 are common across many organizations that compete within the same/similar/overlapping talent pools, one use case for the computing system 100 may be to allow learners/candidates to port their learning history across various positions and various organizations into one cohesive learning “passport” that covers all of these career stops. Such a passport may include concepts space(s) and corresponding concept space path(s), and potentially data identifying related/corresponding embedding mechanisms for these concepts spaces, as discussed herein. A learner 120 (a candidate) or an evaluator 124 of the computing system 100 may upload this passport information to the computing system 100 of the new organization and use the computing system 100 as described to evaluate the learner 120 for fitness for one or more roles of the organization. This may enable, for example, a learner 120 to demonstrate their suitability for new roles to the potential employer and/or allow the potential employer to focus their interviewing efforts on areas where the candidates might be weaker.

Accordingly, it may be understood that the computing system 100 may be used provide granular data to managers, HR professionals, etc., such that they can make better-informed decisions.

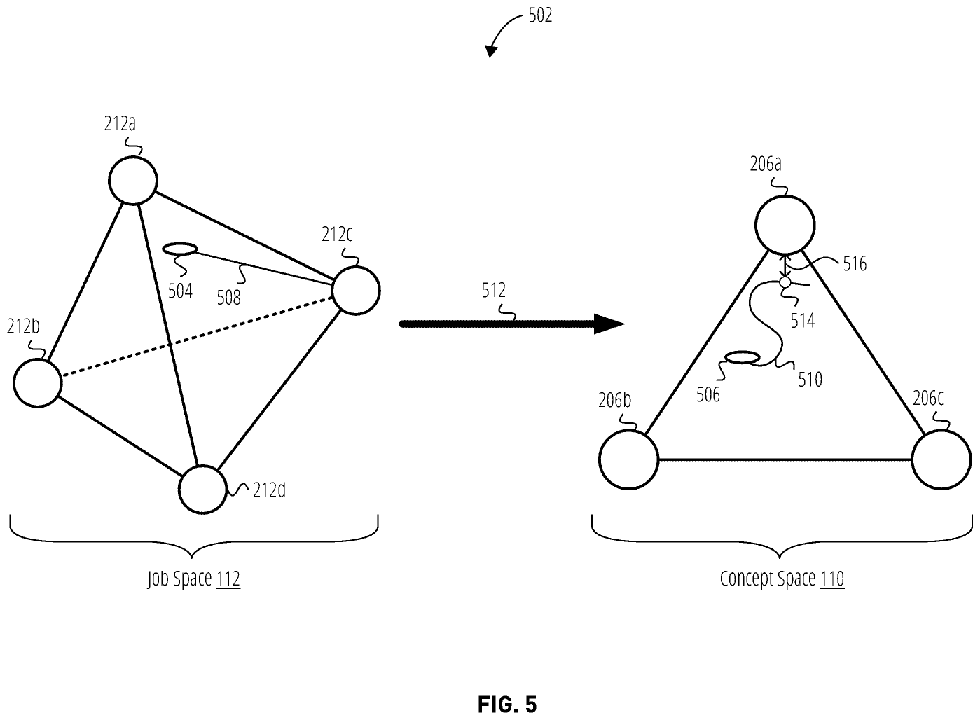

It is also contemplated that the computing system 100 (e.g., the affinity assessor 116) may be configured to make a learning recommendation about/for a learner. FIG. 5 illustrates aspects for generating a learning recommendation using a concept space 110 and a job space 112, according to embodiments discussed herein.

For example, it may be desirable for a learner to develop/improve their affinity for a job/role represented by the job node 212c within the job space 112. This desire may be driven by, for example, career goals of the learner and/or plans for the learner by a manager, HR professional, etc. of the organization.

A current position 504 of the learner within the job space 112 may be established (e.g., ultimately based on the analysis of the learner's currently applicable concept space path 204 within the concept space 110, as was described in relation to FIG. 2). Then, starting with this current position 504, the computing system 100 may (e.g., per instructional input at the user interface 118 by a learner 120 or an evaluator 124) generate a proposed job space path 508 in the job space 112 that leads from the current position 504 of the learner 120 in the job space 112 to the job node 212c, as illustrated.

Then, because each of the concept space 110 and the job space 112 are contextualized according to the same embedding mechanism 108, a prospective concept space path 510 that corresponds to the proposed job space path 508 can be mapped for the learner.

To map locations in the job space 112 to locations in the concept space 110, the computing system 100 (e.g., the affinity assessor 116) may construct/use an R*N dimensional “dyadic” matrix K·J^{T}. This matrix may be denoted herein as L′. Then, given an M-dimensional location in the job space eⱼ, a corresponding M-dimensional location in concept space eₖ may be determined by an operation 512 using eⱼ and L as follows by Equation (2):

$${e}_{k} = {L}^{′ T} {e}_{j} \qquad Eq . ( 2 )$$

FIG. 5 illustrates the case where points on the proposed job space path 508 have been mapped to corresponding points on the prospective concept space path 510 through the use of the operation 512. Note that in FIG. 5, the current position 504 of the learner on the proposed job space path 508 in job space 112 corresponds to the current position 506 of the learner on the corresponding prospective concept space path 510 in the concept space 110.

Then, corresponding to the prospective concept space path 510, a (prospective) affinity of the learner to content represented by the concept nodes 206a, 206b, and 206c may be understood as a vector of numbers, where each number corresponds to a distance (e.g., a distance of closest approach) on the prospective concept space path 510 to the respective concept nodes 206a, 206b, and 206c.

For example, the illustrated point 514 on the prospective concept space path 510 corresponds to a distance of closest approach 516 from the prospective concept space path 510 to the concept node 206a. Accordingly, the value for the concept node 206a in the vector of numbers for the prospective concept space path 510 of this learner may be controlled by this distance of closest approach 516.

It may further be that the computing system 100 determines that the distance of closest approach 516 to the concept node 206a is the smallest distance of closest approach for the prospective concept space path 510 with respect all such distances for all of the concept nodes 206a, 206b, and 206c in the concept space 110 (e.g., that the concept node 206a is the closest concept node to the prospective concept space path 510). Based on this conclusion, the concept space 110 identifies the concept node 206a as most heavily representing content that is useful for increasing the affinity of the learner 120 for the job/role represented by the job node 212c and that will thus is most relevant to traveling the corresponding proposed job space path 508.

The computing system 100 may accordingly report/recommend content corresponding to the concept node 206a to the learner 120 as a “learning plan” for the learner 120. This informs the learner 120/the evaluator 124 that the learner 120 can work with this identified content (e.g., via the knowledge assessor 122) in order to increase their affinity for the identified job/role represented by the job node 212c.

It is contemplated that, in some cases, a learning plan could further take into account/recommend content corresponding to the content node 206b and/or to the content node 206c, but on a lighter/less prioritized basis (e.g., corresponding to the relatively longer distances of closest approach of these content nodes to the prospective concept space path 510).

Providing a capability for the computing system 100 to map out a learning plan as described may provide the learner 120 an increased sense of direction, accomplishment, and/or ownership within the context of the organization, which is useful when considering the shifting demographics of the workforce that the organization competes to attract and retain. Further, the development of a learning plan in this manner helps to ensure that the learner 120 is being directed to content that is applicable to the identified job/role represented by the job node 212c.

In one example, a learner 120 interfaces with the computing system 100 through the user interface 118. As the user interacts with the knowledge assessor 122 of the computing system 100, a path for the user is generated within the concept space 110. This path may be determined based on a current interaction of the learner 120 with the knowledge assessor 122, information saved at the computing system 100 (e.g., at the knowledge assessor 122) about prior interaction(s) of the learner 120 with the knowledge assessor 122, and/or path data as provided to the computing system 100 from an external source (e.g., by the learner 120 or an evaluator 124). The path of the learner 120 in the concept space 110 is mapped to the job space 112.

Based on the path of the job space 112, a proximity of the current position of the learner 120 in the job space to a job represented in the job space may be determined. This job may be selected by the learner 120 and/or the evaluator 124, and may represent a job for which it is desired that the learner 120 increase their affinity. A proposed job space path from the location of the learner 120 in the jobs space is then proposed/generated by the computing system 100 and mapped back into the concept space 110. One or more concept nodes may corresponding to (e.g., proximate to), this new concept space path may then be identified as relevant for increasing the affinity of the learner 120 for the desired job. Accordingly, the knowledge assessor 122 may operate with this content when assessing (training) the content database 102, such that the affinity of the learner 120 for the desired job is increased as a result.

The computing system 100 accordingly more efficiently, quickly, and accurately identifies whether a candidate's experience is relevant to one or more than one position than what is possible with prior systems. Further, the computing system 100 more efficiently, quickly, and accurately identifies and delivers training materials, topics, concepts, etc., that are directly relevant to increasing a candidate's affinity/compatibility with a desired job.

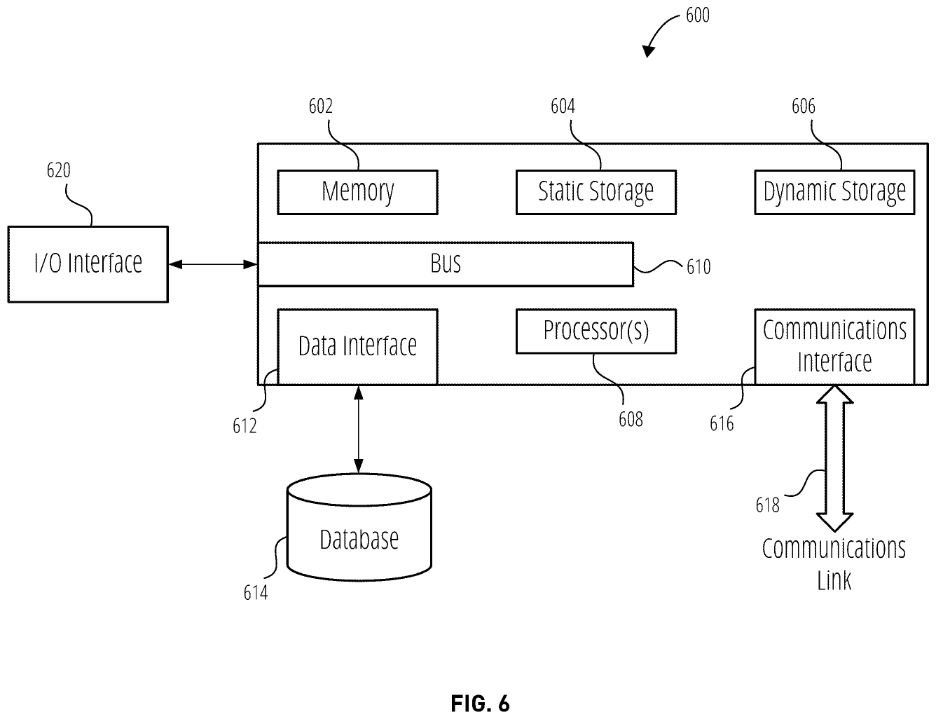

FIG. 6 is a schematic diagram of a computing system 600 which may be used to implement various embodiments in the examples described herein. This disclosure contemplates any suitable number of the computing systems 600. For example, a computing system 600 may be a server, a desktop computing system, a mainframe, a mesh of computing systems, a laptop or notebook computing system, a tablet computing system, or a combination of two or more of these. Where appropriate, the computing system 600 may include one or more computing systems; be unitary or distributed; span multiple locations; span multiple machines; span multiple data centers; or reside in a cloud, which may include one or more cloud components in one or more networks.

The computing system 600 includes a bus 610 (e.g., an address bus and a data bus) or other communication mechanism for communicating information, which interconnects subsystems and devices, such as one or more processors 608, a memory 602 (e.g., random access memory (RAM)), a static storage 604 (e.g., read only memory (ROM)), a dynamic storage 606 (e.g., magnetic or optical), a communications interface 616 (e.g., a modem, an Ethernet card, a network interface controller (NIC) or network adapter for communicating with an Ethernet or other wire-based network, a wireless NIC (WNIC) or wireless adapter for communicating with a wireless network, such as a Wi-Fi network, etc.), and/or an input/output (I/O) interface 620 (e.g., a keyboard, a keypad, a mouse, and/or a microphone, etc.). In particular embodiments, a computing system 600 may include one or more of any such components.

In particular embodiments, the one or more processors 608 include hardware for executing instructions, such as those making up a computer program. The one or more processors 608 include circuitry for performing various processing functions, such as executing specific software for performing specific calculations or tasks.

In particular embodiments, the I/O interface 620 includes hardware, software, or both, providing one or more interfaces for communication between the computing system 600 and one or more I/O devices. The computing system 600 may include one or more of these I/O devices, where appropriate. One or more of these I/O devices may enable communication between a person and the computing system 600.

In particular embodiments, the communications interface 616 includes hardware, software, or both providing one or more interfaces for communication (such as, for example, packet-based communication) between the computing system 600 and one or more other computer systems or one or more networks. One or more memory buses (which may each include an address bus and a data bus) may couple the one or more processors 608 to the memory 602. The bus 610 may include one or more memory buses, as described below. In particular embodiments, one or more memory management units (MMUs) reside between the one or more processors 608 and the memory 602 and facilitate accesses to the memory 602 as requested by the one or more processors 608. In particular embodiments, the bus 610 includes hardware, software, or both coupling components of the computing system 600 to each other.

According to particular embodiments, the computing system 600 performs specific operations by the one or more processors 608 executing one or more sequences of one or more instructions contained in the memory 602. Such instructions may be read into the memory 602 from another computer readable/usable medium, such as the static storage 604 or the dynamic storage 606. In alternative embodiments, hard-wired circuitry may be used in place of or in combination with software instructions. Thus, particular embodiments are not limited to any specific combination of hardware circuitry and/or software. In one embodiment, the term “logic” shall mean any combination of software or hardware that is used to implement all or part of particular embodiments disclosed herein.

The term “computer readable medium” or “computer usable medium” as used herein refers to any medium that participates in providing instructions to the one or more processors 608 for execution. Such a medium may take many forms, including but not limited to, nonvolatile media and volatile media. Non-volatile media includes, for example, optical or magnetic disks, such as the static storage 604 or dynamic storage 606. Volatile media includes dynamic memory, such as the memory 602.

The computing system 600 may transmit and receive messages, data, and instructions, including program, e.g., application code, through the communications link 618 and the communications interface 616. Received program code may be executed by the one or more processors 608 as it is received, and/or stored in the static storage 604 or the dynamic storage 606, or other storage for later execution. A database 614 may be used to store data accessible by the computing system 600 by way of the data interface 612.

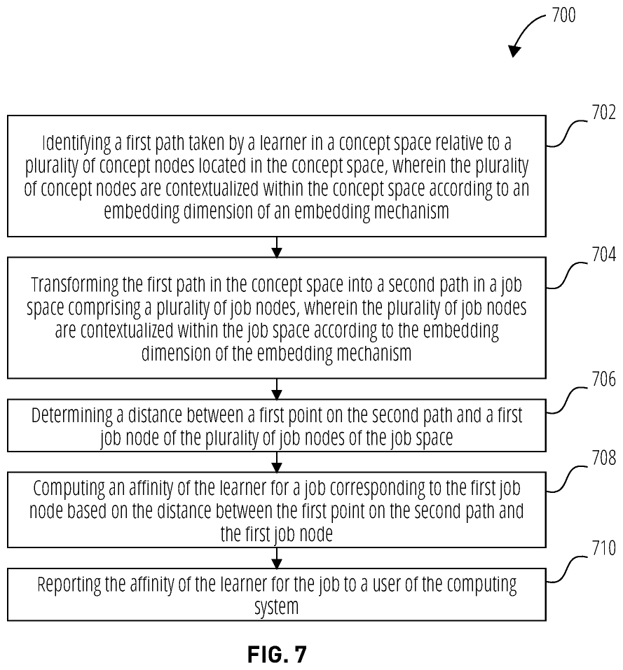

FIG. 7 illustrates a method 700 of a computing system, according to embodiments discussed herein. The method 700 includes identifying 702 a first path taken by a learner in a concept space relative to a plurality of concept nodes located in the concept space, wherein the plurality of concept nodes are contextualized within the concept space according to an embedding dimension of an embedding mechanism. The method 700 further includes transforming 704 the first path in the concept space into a second path in a job space comprising a plurality of job nodes, wherein the plurality of job nodes are contextualized within the job space according to the embedding dimension of the embedding mechanism. The method 700 further includes determining 706 a distance between a first point on the second path and a first job node of the plurality of job nodes of the job space. The method 700 further includes computing 708s an affinity of the learner for a job corresponding to the first job node based on the distance between the first point on the second path and the first job node. The method 700 further includes reporting 710 the affinity of the learner for the job to a user of the computing system.

In some embodiments of the method 700, the transforming the first path into the second path comprises multiplying a first vector representing a first location in the concept space that is on the first path by a transform matrix L to calculate a second vector representing a second location in the job space that is on the second path. In some such embodiments, the transform matrix L equals K·J^{T}, where: K is a content matrix representing a first arrangement of the plurality of concept nodes within the concept space according to the embedding dimension; and J is a job matrix representing a second arrangement of the plurality of job nodes within the job space according to the embedding dimension. Further note that in some of these cases, the method 700 further includes one or more of: calculating the content matrix K; calculating the content matrix J; and calculating the transform matrix L. In some such embodiments, the first vector comprises a first plurality of values corresponding to the plurality of concept nodes that indicate first affinities for the plurality of concept nodes at the first location in the concept space; and the second vector comprises a second plurality of values corresponding to the plurality of job nodes that indicate second affinities of the plurality of job nodes at the second location in the job space.

In some embodiments of the method 700, the first point on the second path is a closest point on the second path to the first job node of a plurality of points on the second path.

In some embodiments, the method 700 further includes selecting the first point on the second path from a plurality of points of the second path based on time information corresponding to the plurality of points on the second path.

In some embodiments, the method 700 further includes using the embedding mechanism to perform the contextualization of the plurality of concept nodes within the concept space. In some of these embodiments, the embedding mechanism parses a content library to generate the plurality of concept nodes.

In some embodiments, the method 700 further includes using the embedding mechanism to perform the contextualization of the plurality of job nodes within the job space. In some of these embodiments, the embedding mechanism parses job information to generate the plurality of job nodes.

In some embodiments of the method 700, the embedding mechanism comprises an LLM.

In some embodiments of the method 700, the first job node represents a plurality of jobs that includes the job.

In some embodiments of the method 700, the reporting the affinity of the learner for the job to the user of the computing system occurs on a user interface (UI) for the computing system.

In some embodiments of the method 700, the contextualization of the plurality of job nodes in the job space corresponds to job characteristics of a plurality of jobs represented by the plurality of job nodes.

In some embodiments of the method 700, the contextualization of the plurality of concept nodes in the concept space corresponds to a plurality of content represented by the plurality of concept nodes.

In some embodiments of the method 700, the learner is an employee of an organization comprising a plurality of jobs represented by the plurality of job nodes.

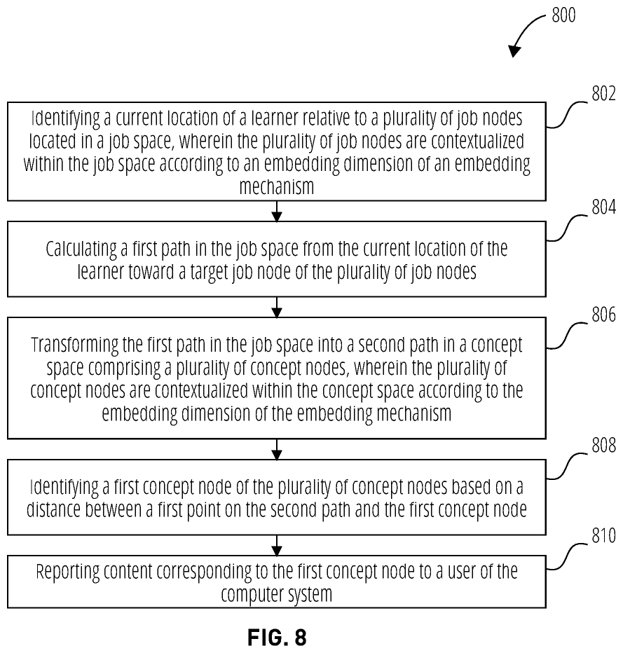

FIG. 8 illustrates a method 800 of a computing system, according to embodiments discussed herein. The method 800 includes identifying 802 a current location of a learner relative to a plurality of job nodes located in a job space, wherein the plurality of job nodes are contextualized within the job space according to an embedding dimension of an embedding mechanism. The method 800 further includes calculating 804 a first path in the job space from the current location of the learner toward a target job node of the plurality of job nodes. The method 800 further includes transforming 806 the first path in the job space into a second path in a concept space comprising a plurality of concept nodes, wherein the plurality of concept nodes are contextualized within the concept space according to the embedding dimension of the embedding mechanism. The method 800 further includes identifying 808 a first concept node of the plurality of concept nodes based on a distance between a first point on the second path and the first concept node. The method 800 further includes reporting 810 content corresponding to the first concept node to a user of the computer system.

In some embodiments of the method 800, the transforming the first path into the second path comprises multiplying a first vector representing a first location in the job space that is on the first path by a transform matrix L′ to calculate a second vector representing a second location in the concept space that is on the second path. In some such embodiments, the transform matrix L′ equals J·K^{T}, where: J is a job matrix representing a first arrangement of the plurality of job nodes within the job space according to the embedding dimension; and K is a content matrix representing a second arrangement of the plurality of concept nodes within the concept space according to the embedding dimension. Note that in some of these cases, the method 800 further includes one or more of: calculating the concept matrix K; calculating the job matrix J; and calculating the transform matrix L′. In some such embodiments, the first vector comprises a first plurality of values corresponding to the plurality of job nodes that indicate first affinities for the plurality of job nodes at the first location in the job space; and the second vector comprises a second plurality of values corresponding to the plurality of concept nodes that indicate second affinities of the plurality of concept nodes at the second location in the concept space.

In some embodiments of the method 800, the first concept node of the plurality of concept nodes is identified for being a closest concept node to the second path of the plurality of concept nodes.

In some embodiments, the method 800 further includes using the embedding mechanism to perform the contextualization of the plurality of concept nodes within the concept space. In some such embodiments, the embedding mechanism parses a content library to generate the plurality of concept nodes.

In some embodiments, the method 800 further includes using the embedding mechanism to perform the contextualization of the plurality of job nodes within the job space. In some such embodiments, the embedding mechanism parses job information to generate the plurality of job nodes.

In some embodiments of the method 800, the embedding mechanism comprises an LLM.

In some embodiments of the method 800, the concept node represents a plurality of contents that includes the content.

In some embodiments of the method 800, the reporting the content corresponding to the concept node to the user of the computer system occurs on a UI for the computing system.

In some embodiments of the method 800, the contextualization of the plurality of job nodes in the job space corresponds to job characteristics of a plurality of jobs represented by the plurality of job nodes.

In some embodiments of the method 800, the contextualization of the plurality of concept nodes in the concept space corresponds to a plurality of content represented by the plurality of concept nodes.

In some embodiments of the method 800, the learner is an employee of an organization comprising a plurality of jobs represented by the plurality of job nodes.

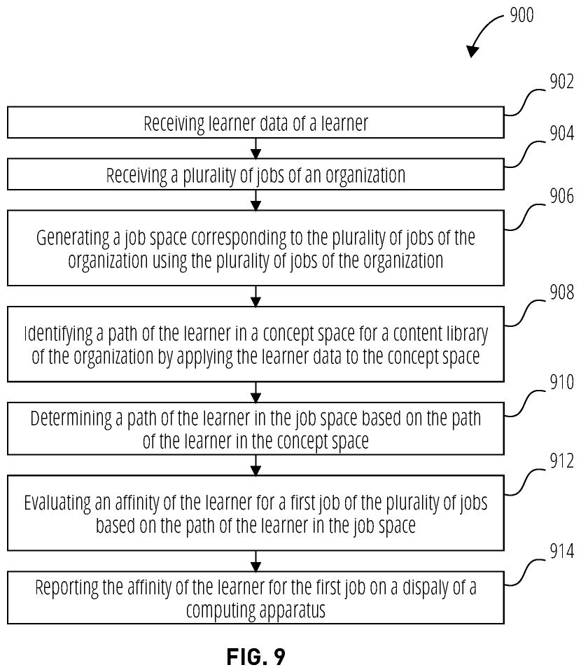

FIG. 9 illustrates a method 900 of a computing apparatus, according to embodiments discussed herein. The method 900 includes receiving 902 learner data of a learner. The method 900 further includes receiving 904 a plurality of jobs of an organization. The method 900 further includes generating 906 a job space corresponding to the plurality of jobs of the organization using the plurality of jobs of the organization. The method 900 further includes identifying 908 a path of the learner in a concept space for a content library of the organization by applying the learner data to the concept space. The method 900 further includes determining 910 a path of the learner in the job space based on the path of the learner in the concept space. The method 900 further includes evaluating 912 an affinity of the learner for a first job of the plurality of jobs based on the path of the learner in the job space. The method 900 further includes reporting 914 the affinity of the learner for the first job on a display of the computing apparatus.

In some embodiments of the method 900, the learner data comprises a data structure describing a path taken by the learner in the concept space.

In some embodiments of the method 900, the affinity of the learner for the first job is evaluated based on a current location of the learner on the path of the learner in the job space.

In some embodiments of the method 900, the affinity of the learner for the first job is evaluated based on a prior location of the learner on the path of the learner in the job space.

In some embodiments of the method 900, the affinity of the learner for the first job is evaluated based on trajectory information for the path of the learner in the job space.

Embodiments discussed herein provide a less biased way of measuring a person's affinity for jobs/roles which define required and/or desirable skills relative to prior methods, based on using the person's educational history as a prior. Given a set of freeform textual descriptions of jobs/roles (e.g., as supplemented by query expansion), the embodiments discussed herein are useful to map between a person's learning history and/or the current state of their knowledge against jobs/roles in a manner that provides granular, actionable data/information for managers, HR professionals, etc., to evaluate the person for a given role in an organization.

Further, by inverting this mapping, embodiments herein are capable of identifying relevant concepts to a job/role and where candidates can improve their knowledge to increase their affinity for the job/role. Further, embodiments herein contemplate that content corresponding to these concepts could be provided/identified to the user/learner for this purpose.

Embodiments herein contemplate that a learning passport used between separate instances of systems as described herein can be leveraged to enable the more efficient interviewing of candidates by enabling interviewers to identify and thus focus on potential weak points of candidates (rather than, e.g., their strongest skills).

Embodiments herein relate to ways of creating less biased recommendations of people to jobs, without reliance on fragile skills ontologies. Further, the use of such embodiments result in valuable time savings for managers, HR professionals, etc., by giving them the ability to see granular data on the suitability of a candidate's educational history to open jobs/roles. Further, embodiments herein enable managers, HR professionals, etc. to see an explainable list of areas where candidates are strong or weak. Further, embodiments herein enable, through the use of learning histories, interviewers to focus on areas of concern for a given applicant, which may result in, for example, reduced interviewing times and/or numbers of rounds. Further, embodiments herein enable users/learners to manage their career paths (e.g., through the identification of content/courses that will move them towards a given job/role within their organization). Further embodiments herein relate a basis for a career learning passport for individuals moving between organizations.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense.

From the foregoing it will be appreciated that, although specific embodiments have been described herein for purposes of illustration, various modifications may be made without deviating from the spirit and scope of the invention.

The particulars shown herein are by way of example and for purposes of illustrative discussion only and are presented in the cause of providing what is believed to be the most useful and readily understood description of the principles and conceptual aspects of various embodiments. In this regard, no attempt is made to show structural details in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one,” or “one or more.” Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A method of a computing system, comprising:
identifying a first path taken by a learner in a concept space relative to a plurality of concept nodes located in the concept space, wherein the plurality of concept nodes are contextualized within the concept space according to an embedding dimension of an embedding mechanism;
transforming the first path in the concept space into a second path in a job space comprising a plurality of job nodes, wherein the plurality of job nodes are contextualized within the job space according to the embedding dimension of the embedding mechanism;
determining a distance between a first point on the second path and a first job node of the plurality of job nodes of the job space;
computing an affinity of the learner for a job corresponding to the first job node based on the distance between the first point on the second path and the first job node; and
reporting the affinity of the learner for the job to a user of the computing system.

2. The method of claim 1, wherein the transforming the first path into the second path comprises multiplying a first vector representing a first location in the concept space that is on the first path by a transform matrix L to calculate a second vector representing a second location in the job space that is on the second path.

3. The method of claim 2, wherein the transform matrix L equals K·J^{T}, where:
K is a content matrix representing a first arrangement of the plurality of concept nodes within the concept space according to the embedding dimension; and
J is a job matrix representing a second arrangement of the plurality of job nodes within the job space according to the embedding dimension.

4. The method of claim 3, further comprising one or more of:
calculating the content matrix K;
calculating the content matrix J; and
calculating the transform matrix L.

5. The method of claim 2, wherein:
the first vector comprises a first plurality of values corresponding to the plurality of concept nodes that indicate first affinities for the plurality of concept nodes at the first location in the concept space; and
the second vector comprises a second plurality of values corresponding to the plurality of job nodes that indicate second affinities of the plurality of job nodes at the second location in the job space.

6. The method of claim 1, wherein the first point on the second path is a closest point on the second path to the first job node of a plurality of points on the second path.

7. The method of claim 1, further comprising selecting the first point on the second path from a plurality of points of the second path based on time information corresponding to the plurality of points on the second path.

8. The method of claim 1, further comprising using the embedding mechanism to perform the contextualization of the plurality of concept nodes within the concept space.

9. The method of claim 8, wherein the embedding mechanism parses a content library to generate the plurality of concept nodes.

10. The method of claim 1, further comprising using the embedding mechanism to perform the contextualization of the plurality of job nodes within the job space.

11. The method of claim 10, wherein the embedding mechanism parses job information to generate the plurality of job nodes.

12. The method of claim 1, wherein the embedding mechanism comprises a large language model (LLM).

13. The method of claim 1, wherein the first job node represents a plurality of jobs that includes the job.

14. The method of claim 1, wherein the reporting the affinity of the learner for the job to the user of the computing system occurs on a user interface (UI) for the computing system.

15. The method of claim 1, wherein the contextualization of the plurality of job nodes in the job space corresponds to job characteristics of a plurality of jobs represented by the plurality of job nodes.

16. The method of claim 1, wherein the contextualization of the plurality of concept nodes in the concept space corresponds to a plurality of content represented by the plurality of concept nodes.

17. The method of claim 1, wherein the learner is an employee of an organization comprising a plurality of jobs represented by the plurality of job nodes.

18. A method of a computing system, comprising:
identify a current location of a learner relative to a plurality of job nodes located in a job space, wherein the plurality of job nodes are contextualized within the job space according to an embedding dimension of an embedding mechanism;
calculating a first path in the job space from the current location of the learner toward a target job node of the plurality of job nodes;
transforming the first path in the job space into a second path in a concept space comprising a plurality of concept nodes, wherein the plurality of concept nodes are contextualized within the concept space according to the embedding dimension of the embedding mechanism;
identifying a first concept node of the plurality of concept nodes based on a distance between a first point on the second path and the first concept node; and
reporting content corresponding to the first concept node to a user of the computer system.

19. The method of claim 18, wherein the transforming the first path into the second path comprises multiplying a first vector representing a first location in the job space that is on the first path by a transform matrix L′ to calculate a second vector representing a second location in the concept space that is on the second path.

20. The method of claim 19, wherein the transform matrix L′ equals J·K^{T}, where:
J is a job matrix representing a first arrangement of the plurality of job nodes within the job space according to the embedding dimension; and
K is a content matrix representing a second arrangement of the plurality of concept nodes within the concept space according to the embedding dimension.

21. The method of claim 20, further comprising one or more of:
calculating the concept matrix K;
calculating the job matrix J; and
calculating the transform matrix L′.

22. The method of claim 19, wherein:
the first vector comprises a first plurality of values corresponding to the plurality of job nodes that indicate first affinities for the plurality of job nodes at the first location in the job space; and
the second vector comprises a second plurality of values corresponding to the plurality of concept nodes that indicate second affinities of the plurality of concept nodes at the second location in the concept space.

23. The method of claim 18, wherein the first concept node of the plurality of concept nodes is identified for being a closest concept node to the second path of the plurality of concept nodes.

24. The method of claim 18, further comprising using the embedding mechanism to perform the contextualization of the plurality of concept nodes within the concept space.

25. The method of claim 24, wherein the embedding mechanism parses a content library to generate the plurality of concept nodes.

26. The method of claim 18, further comprising using the embedding mechanism to perform the contextualization of the plurality of job nodes within the job space.

27. The method of claim 26, wherein the embedding mechanism parses job information to generate the plurality of job nodes.

28. The method of claim 18, wherein the embedding mechanism comprises a large language model (LLM).

29. The method of claim 18, wherein the concept node represents a plurality of contents that includes the content.

30. The method of claim 18, wherein the reporting the content corresponding to the concept node to the user of the computer system occurs on a user interface (UI) for the computing system.

31. The method of claim 18, wherein the contextualization of the plurality of job nodes in the job space corresponds to job characteristics of a plurality of jobs represented by the plurality of job nodes.

32. The method of claim 18, wherein the contextualization of the plurality of concept nodes in the concept space corresponds to a plurality of content represented by the plurality of concept nodes.

33. The method of claim 18, wherein the learner is an employee of an organization comprising a plurality of jobs represented in the plurality of job nodes.

34. A learner evaluation system comprising:
one or more processors; and
a memory storing instructions that, when executed by the one or more processors, configure the learner evaluation system to:
receive learner data of a learner;
receive a plurality of jobs of an organization;
generate a job space corresponding to the plurality of jobs of the organization using the plurality of jobs of the organization;
identify a path of the learner in a concept space for a content library of the organization by applying the learner data to the concept space;
determine a path of the learner in the job space based on the path of the learner in the concept space;
evaluate an affinity of the learner for a first job of the plurality of jobs based on the path of the learner in the job space; and
report the affinity of the learner for the first job on a display of the computing apparatus.

35. The learner evaluation system of claim 34, wherein the learner data comprises a data structure describing a path taken by the learner in the concept space.

36. The learner evaluation system of claim 34, wherein the affinity of the learner for the first job is evaluated based on a current location of the learner on the path of the learner in the job space.

37. The learner evaluation system of claim 34, wherein the affinity of the learner for the first job is evaluated based on a prior location of the learner on the path of the learner in the job space.

38. The learner evaluation system of claim 34, wherein the affinity of the learner for the first job is evaluated based on trajectory information for the path of the learner in the job space.

39. A computing system for dynamically assessing skills of a user and identifying a job for which the user has an affinity, comprising:
a user interface;
one or more processors; and
a memory having instructions that, when executed by the one or more processors, cause the computing system to:
generate a concept space by contextualizing contents of a content database with an embedding mechanism;
generate a jobs space by contextualizing contents of a jobs database with the embedding mechanism;
assess a knowledge of the user using a knowledge assessor to map a first path for the user in the concept space;
mapping the first path into a second path in the jobs space based on a relationship between the concept space and the jobs space defined by the embedding mechanism
determine an affinity of the user for a job represented by a job node in the job space by calculating a distance of closest approach from the second path to the job node; and
displaying the affinity of the user on the user interface.

40. A computing system for dynamically determining a learning plan for a user to increase an affinity of the user for a job, comprising:
a user interface;
one or more processors; and
a memory having instructions that, when executed by the one or more processors, cause the computing system to:
generate a concept space by contextualizing contents of a content database with an embedding mechanism;
generate a jobs space by contextualizing contents of a jobs database with the embedding mechanism;
determine a current concept space position of the user in the concept space;
mapping the current concept space position of the user into a current job space position of the user in the jobs space based on a relationship between the concept space and the jobs space defined by the embedding mechanism;
receive, from the user, via the user interface, an identification of the job, wherein the job is represented by a job node in the job space;
generating a proposed job space path from the current job space position of the user to the job node representing the job;
mapping the proposed job space path into a prospective concept space path in the concept space based on the relationship between the concept space and the jobs space defined by the embedding mechanism;
identifying a concept node in the concept space having a closest distance of closest approach to the prospective concept space path; and
training the user with content associated with the concept node via the user interface.
